(19) United States
(12) Patent Application Publication
(10) Pub. No.: US 2022/0268915 A1
(43) Pub. Date: Aug. 25, 2022

(54) RADAR SYSTEM, IMAGING METHOD, AND IMAGING PROGRAM

(71) Applicant: NEC Corporation, Minato-ku, Tokyo (JP)

(72) Inventors: Kazumine OGURA, Tokyo (JP); Tatsuya SUMIYA, Tokyo (JP); Masayuki ARIYOSHI, Tokyo (JP)

(73) Assignee: NEC Corporation, Minato-ku, Tokyo (JP)

(21) Appl. No.: 17/620,560

(22) PCT Filed: Jun. 28, 2019
(86) PCT No.: PCT/JP2019/025792

§ 371 Date: Dec. 17, 2021

(51) Int. Cl. G01S 13/58; G01S 7/41

(52) U.S. Cl. CPC G01S 13/588; G01S 13/584; G01S 13/585; G01S 7/415

(57) ABSTRACT

The radar system 11 comprises a plurality of transmission antennas 12 which irradiate electromagnetic waves, a plurality of receiving antennas 13 which receive the irradiated electromagnetic waves that have been reflected and generating measurement signals, radar signal transmission and receiving means 14 for obtaining the measurement signals, movement estimation means 15 for estimating the movement of an object, and motion-compensated image generation means 16 for generating a radar image based on the measurement signals and the estimated object movement.

### TECHNICAL FIELD

The present invention relates to a radar system, an imaging method, and an imaging program for receiving electromagnetic waves reflected by an object and performing imaging.

### BACKGROUND ART

A body scanner system, as illustrated in FIG. 18, has been introduced in airports and the like. In the body scanner system, an electromagnetic wave such as a millimeter wave is irradiated to an object (such as a human body) 800 that stops within an area 802. A plurality of radars (including a transmission antenna and a receiving antenna) 804 are installed on a side panel 803. Electromagnetic waves reflected by the object 800 are measured, and imaging (imaging) is performed based on the measurement signals (radar signals) (refer to non-patent literature 1, for example). Based on the images (radar images), for example, an inspection is performed to determine whether the object 800 has a suspicious object.

Note that, non-patent literature 2 describes a method for measuring the velocity of an object in an image by estimating the optical flow between image frames.

### CITATION LIST

### Patent Literature

PTL 1: Japanese Patent Laid-Open No. H11-94931

### Non-Patent Literature

NPL 1: D. M. Sheen, et al., “Three-Dimensional Millimeter-Wave Imaging for Concealed Weapon Detection,” IEEE Transactions on Microwave Theory and Techniques, vol. 49, No. 9, September 2001

NPL 2: B. D. Lucas, T. Kanade, “An iterative image registration technique with an application to stereo vision,” Proc. 7th International Joint Conference on Artificial Intelligence, pp. 674-679, 1981

### SUMMARY OF INVENTION

### Technical Problem

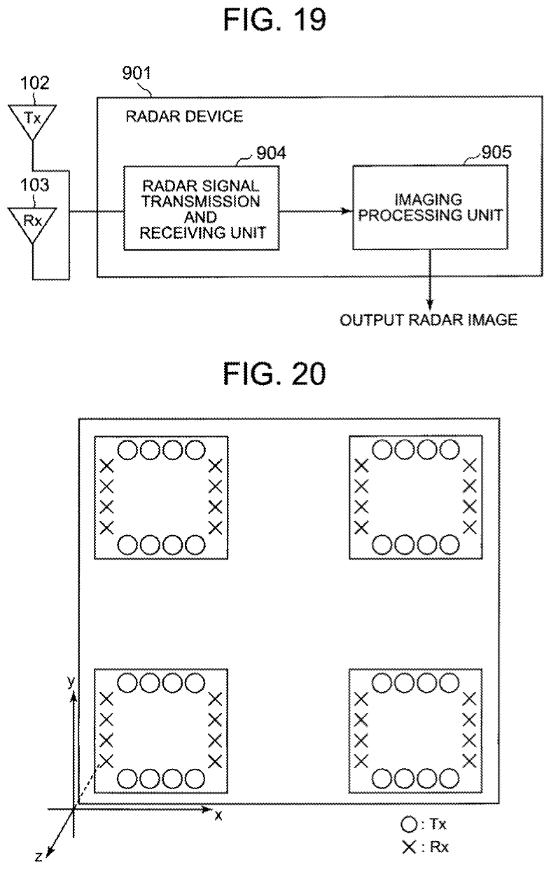

FIG. 19 is a block diagram showing an example configuration of a general radar device. The radar device 901 shown in FIG. 19 includes a transmission antenna (Tx) 102 that emits electromagnetic waves, a receiving antenna (Rx) 103 that receives reflected electromagnetic waves, a radar signal transmission and receiving unit 904, and an imaging processing unit 905. The transmission antenna 102 and the receiving antenna 103 correspond to the radar 804 in FIG. 18. Although one transmission antenna 102 and one receiving antenna 103 are illustrated in FIG. 19, practically, a large number of transmission antennas 102 and a large number of receiving antennas 103 are installed. Hereinafter, the system including the transmission antenna, the receiving antenna, and the radar device is referred to as a radar system.

The radar signal transmission and receiving unit 904 makes the transmission antenna 102 emit electromagnetic waves. The radar signal transmission and receiving unit 904 inputs a radar signal from the receiving antenna 103. The imaging processing unit 905 generates a radar image based on the radar signal.

FIG. 20 is a schematic diagram showing an example of an antenna arrangement in an electronically scanned array including a plurality of transmission antennas 102 and a plurality of receiving antennas 103. A three-dimensional coordinate system is also shown in FIG. 20. The electronically scanned array comprises, for example, Multiple-Input and Multiple-Output (MIMO) in which a plurality of transmission antennas 102 transmit signals of the same frequency. The electronically scanned array may also comprise a monostatic transmission and receiving antenna element in which the transmission antenna 102 and the receiving antenna 103 are common. The array may be comprised so that radar signals are captured through the receiving antenna 103 while the transmission antenna 102 that irradiates electromagnetic waves from the plurality of transmission antennas 102 is switched.

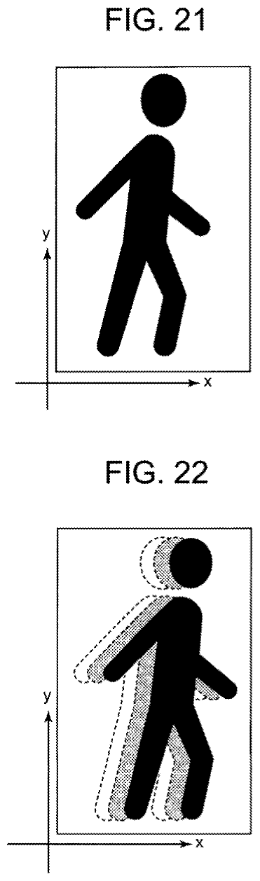

An imaging device that applies electromagnetic waves, such as a general body scanner, is intended to image a stationary object 800. That is, the radar device 901 generates a radar image based on the assumption that the object is stationary when it is irradiated with electromagnetic waves. FIG. 21 is an explanatory diagram showing an example of a radar image of a stationary object 800.

When the object 800 moves, such as when the object 800 walks through the passage 801 without constraint in its movement, a blur (image blur) may occur in the radar image, as illustrated in FIG. 22. When the blur occurs, a detection object (for example, a suspicious object) accompanying the object 800 may be buried in the radar image. Therefore, when the radar image is used for various purposes, it is desirable to generate a radar image in which the blur is suppressed.

In addition, in the case where the object 800 moves without constraint, it is difficult to predict the movement of the object 800, and it is difficult to suppress the blur by taking the movement of the object 800 into account.

Patent literature 1 describes a radar device that generates an image by correlation processing on two video signals based on received signals of a receiving radar having different obtainment times. The radar device described in patent literature 1 predicts the position of an object in one video signal in the other video signal, and corrects the position of the object in the other video signal to the predicted position. However, there is no disclosure of blur suppression in patent literature 1.

It is an object of the present invention to provide a radar system, an imaging method and an imaging program capable of generating a radar image with suppressed blur even when an object is moving.

### Solution to Problem

A radar system according to the present invention includes a plurality of transmission antennas which irradiate electromagnetic waves, a plurality of receiving antennas which receive the irradiated electromagnetic waves that have been reflected and generating measurement signals, radar signal transmission and receiving means for obtaining the measurement signals, movement estimation means for estimating a movement of an object, and motion-compensated image generation means for generating a radar image, based on the measurement signals and the estimated object movement.

An imaging method according to the present invention includes obtaining the measurement signals based on reflected waves of electromagnetic waves irradiated from a plurality of transmission antennas, estimating a movement of an object, and generating a radar image, based on the measurement signals and the estimated object movement.

An imaging program according to the present invention causes a computer to execute a process of obtaining the measurement signals based on reflected waves of electromagnetic waves irradiated from a plurality of transmission antennas, a process of estimating a movement of an object, and a process of generating a radar image based on the measurement signals and the estimated object movement.

### Advantageous Effects of Invention

According to the present invention, it is possible to obtain a radar image with suppressed blur even when an object is moving.

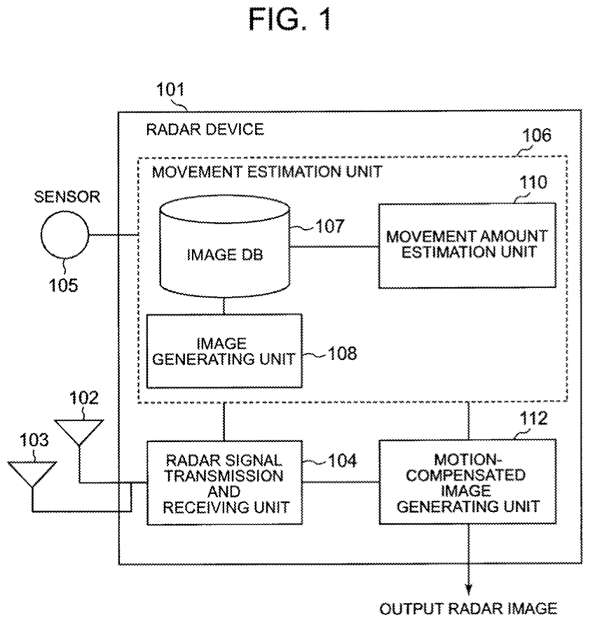

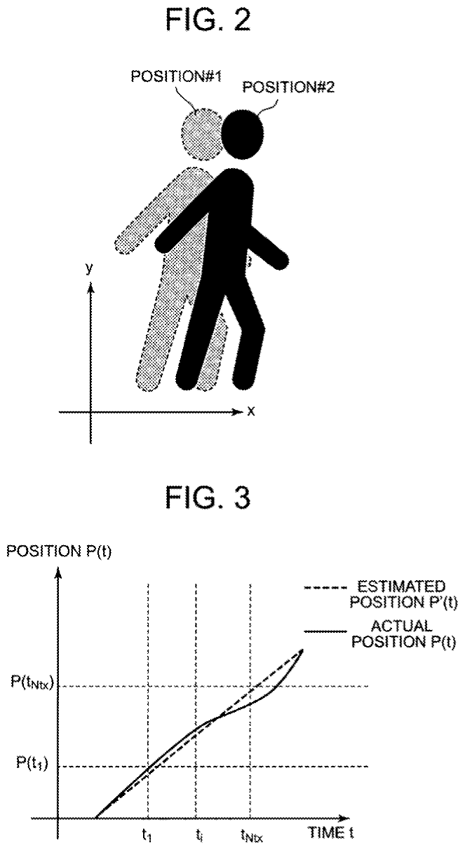

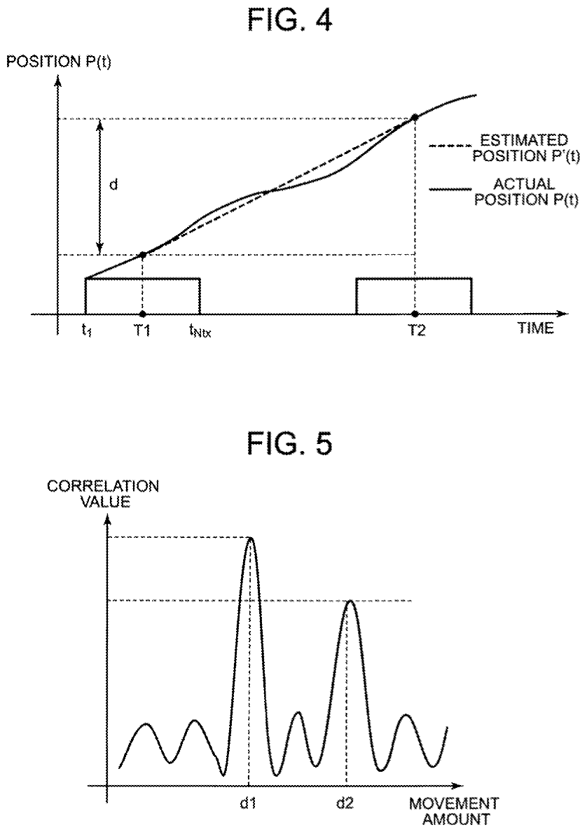

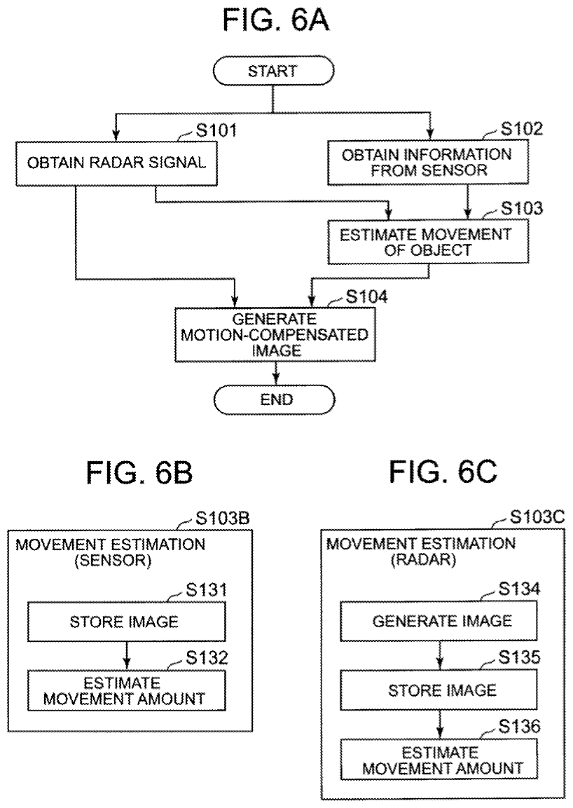

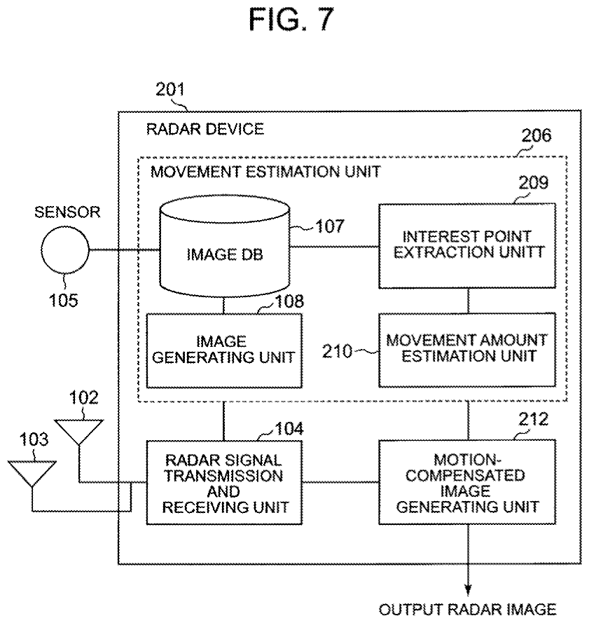

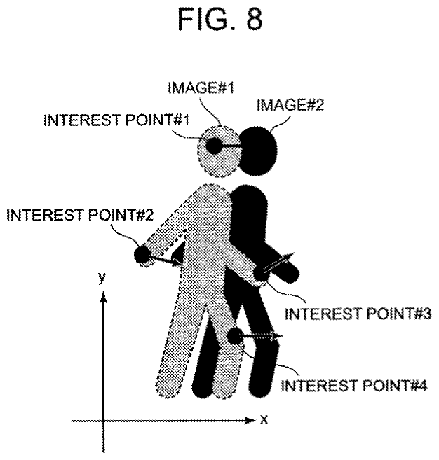

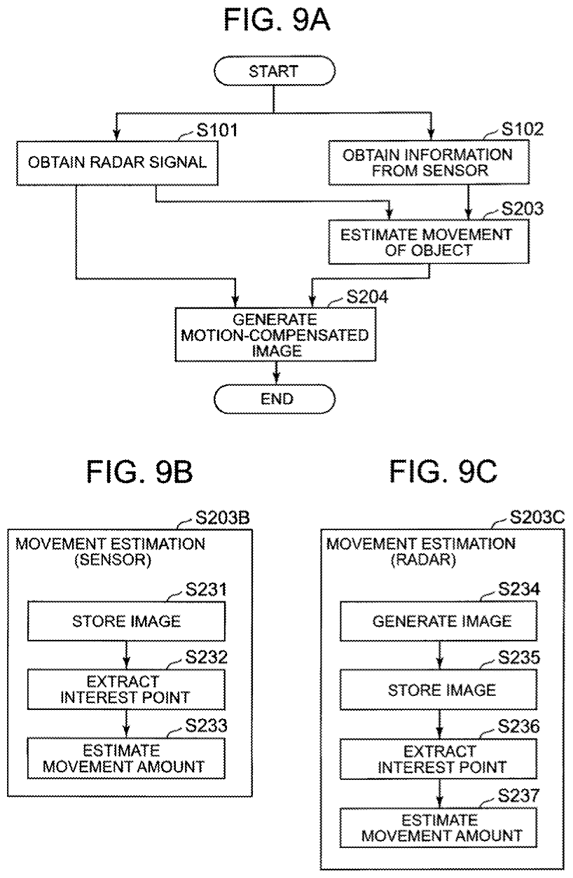

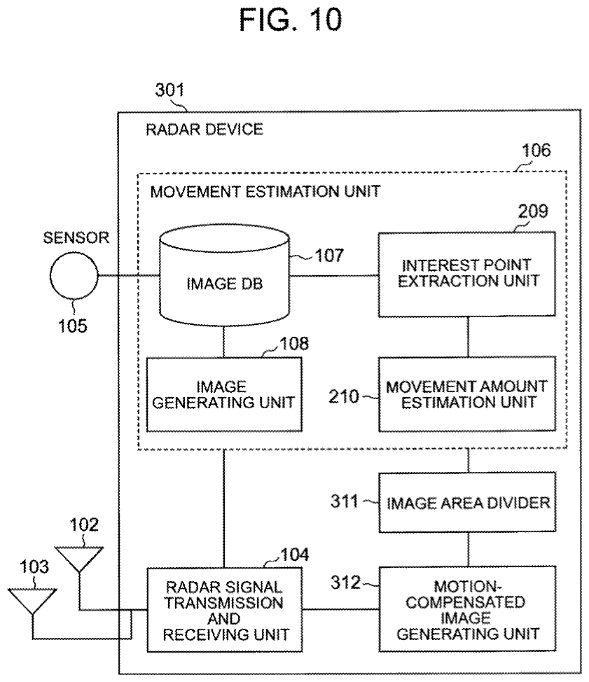

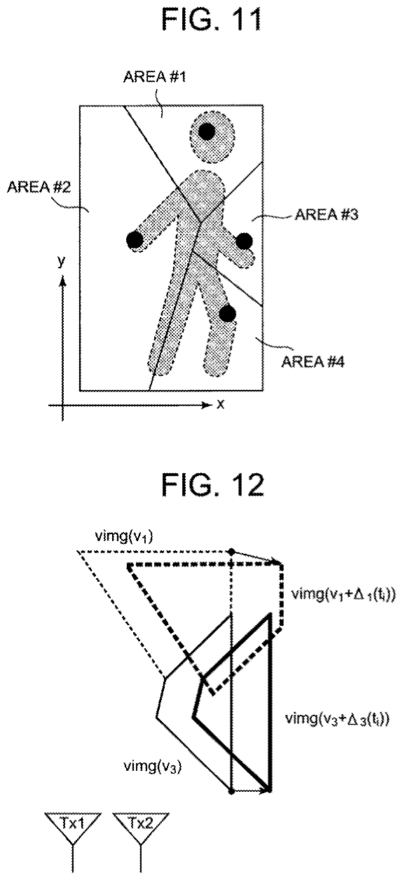

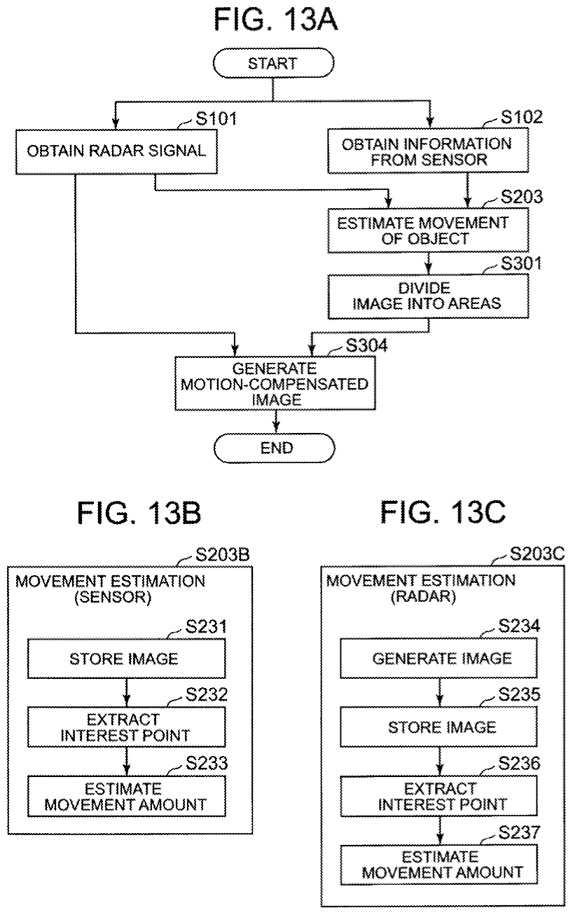

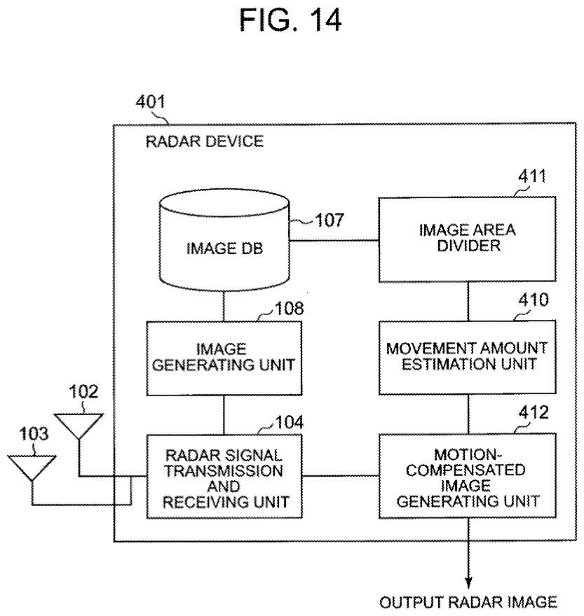

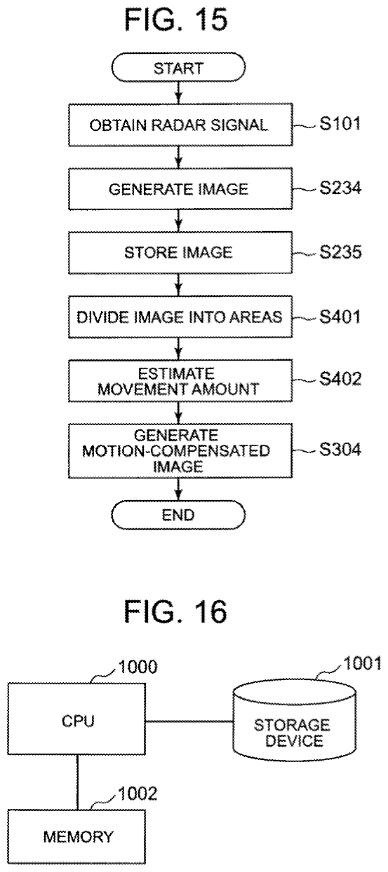

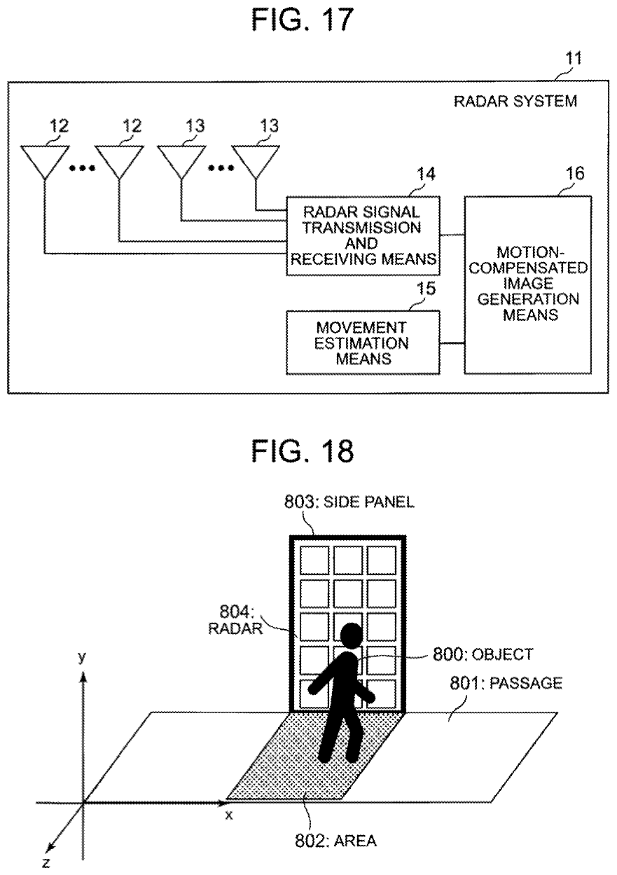

### BRIEF DESCRIPTION OF DRAWINGS

[FIG. 1] It depicts a block diagram showing a configuration example of the radar system of the first example embodiment.

[FIG. 2] It depicts an explanatory diagram showing a position of an object at the irradiation time.

[FIG. 3] It depicts an explanatory diagram showing a position of an object at each time.

[FIG. 4] It depicts an explanatory diagram showing imaging time of a radar image and movement amount of an object.

[FIG. 5] It depicts an explanatory diagram showing estimated movement amount and its correlation value.

[FIG. 6A] It depicts a flowchart showing the operation of the radar system of the first example embodiment.

[FIG. 6B] It depicts a flowchart showing the operation of the radar system of the first example embodiment.

[FIG. 6C] It depicts a flowchart showing the operation of the radar system of the first example embodiment.

[FIG. 7] It depicts a block diagram showing a configuration example of the radar system of the second example embodiment.

[FIG. 8] It depicts an explanatory diagram showing an example of an interest point extracted by corner detection.

[FIG. 9A] It depicts a flowchart showing the operation of the radar system in the second example embodiment.

[FIG. 9B] It depicts a flowchart showing the operation of the radar system in the second example embodiment.

[FIG. 9C] It depicts a flowchart showing the operation of the radar system in the second example embodiment.

[FIG. 10] It depicts a block diagram showing a configuration example of the radar system of the third example embodiment.

[FIG. 11] It depicts an explanatory diagram showing an example of an area divided image based on an interest point.

[FIG. 12] It depicts an explanatory diagram showing the movement amount corresponding to the area obtained by division.

[FIG. 13A] It depicts a flowchart showing the operation of the radar system of the third example embodiment.

[FIG. 13B] It depicts a flowchart showing the operation of the radar system of the third example embodiment.

[FIG. 13C] It depicts a flowchart showing the operation of the radar system of the third example embodiment.

[FIG. 14] It depicts a block diagram showing a configuration example of the radar system of the fourth example embodiment.

[FIG. 15] It depicts a flowchart showing the operation of the radar system of the fourth example embodiment.

[FIG. 16] It depicts a block diagram showing an example of a computer with a CPU.

[FIG. 17] It depicts a block diagram showing the main part of the radar system.

[FIG. 18] It depicts an explanatory diagram showing a body scanner system.

[FIG. 19] It depicts a block diagram showing a configuration example of a general radar system.

[FIG. 20] It depicts a schematic diagram showing an example of an antenna arrangement in an electronically scanned array including a plurality of transmission antennas and a plurality of receiving antennas.

[FIG. 21] It depicts an explanatory diagram showing an example of a radar image of a stationary object.

[FIG. 22] It depicts an explanatory diagram for explaining a blur caused by the movement of an object.

### DESCRIPTION OF EMBODIMENTS

Hereinafter, example embodiments of the present invention are described with reference to the drawings.

### Example Embodiment 1

FIG. 1 is a block diagram showing a configuration example of the radar system of the first example embodiment. The radar system of the first example embodiment includes a radar device 101, a transmission antenna 102, a receiving antenna 103, an external sensor (hereinafter, referred to as a sensor) 105. Although FIG. 1 illustrates one transmission antenna 102 and one receiving antenna 103, practically, a large number of transmission antennas 102 and a large number of receiving antennas 103 are installed.

The radar device 101 includes a radar signal transmission and receiving unit 104 that instructs the transmission antenna 102 and the receiving antenna 103 to transmission and receiving electromagnetic waves, a movement estimation unit 106 that has a function of estimating a movement of an object 800 (refer to FIG. 18) that may appear in the radar image, and a motion-compensated image generating unit 112 that generates a radar image using the radar signals and the estimated object movement.

When the transmission antenna 102 receives an irradiation instruction from the radar signal transmission and receiving unit 104, the transmission antenna 102 starts irradiating electromagnetic waves. For example, a continuous wave (CW), a frequency modulated continuous wave (FMCW), and a stepped FMCW can be used as the electromagnetic wave to be irradiated from the transmission antenna 102. Hereinafter, it is assumed that Stepped FMCW, whose frequency changes according to time, is used, but the use of Stepped FMCW is an example. The frequency of an electromagnetic wave is expressed as f(t).

The receiving antenna 103 receives a reflected wave of the electromagnetic wave irradiated by the transmission antenna 102, and outputs a measurement signal (radar signal) based on the reflected wave to the radar signal transmission and receiving unit 104. Hereafter, the radar signal based on the reflected wave received at time t by the receiving antenna j from the electromagnetic wave irradiated by the transmission antenna i is expressed as s_{i,j}(t).

The radar signal transmission and receiving unit 104 instructs the transmission antenna 102 to irradiate electromagnetic waves according to a predetermined irradiation order and irradiation time. The radar signal transmission and receiving unit 104 inputs a radar signal from the receiving antenna 103. The radar signal transmission and receiving unit 104 outputs the radar signal and the irradiation time (irradiation start time) of the electromagnetic wave of the transmission antenna 102 to the motion-compensated image generating unit 112. The radar signal transmission and receiving unit 104 also outputs the radar signal and the irradiation time of the electromagnetic wave of the transmission antenna 102 to the movement estimation unit 106, if necessary.

The sensor 105 outputs the position or velocity (specifically, data indicating the position or velocity) or image of the object 800 to the movement estimation unit 106. However, if the movement of the object is estimated based on the radar image in the movement estimation unit 106, the sensor 105 is not necessary.

The following description illustrates a case in which the example embodiment is applied to the body scanner system illustrated in FIG. 18. However, the application of this and other example embodiments is not limited to body scanner systems. As illustrated in FIG. 18, an object 800 walks in the x direction. The radar 804 used to generate the radar image is installed on a side panel 803. It is assumed that a MIMO antenna (refer to FIG. 20) comprising a plurality of transmission antennas 102 and receiving antennas 103 is used as the radar 804.

Note that this example embodiment and other example embodiments are effective for the movement of any object 800. This example embodiment and other example embodiments are also effective for a radar installed at arbitrary position. In other words, the installation position of the radar 804 illustrated in FIG. 18 is an example. In addition, in this and other example embodiments, in order to suppress blur caused by movement of the object 800 during irradiation of electromagnetic waves from the transmission antenna 102, a radar imaging system using a plurality of transmission antennas 102, or a radar imaging system that uses a plurality of frequencies radar imaging system and a plurality of transmission antennas 102 and a plurality of frequencies.

Hereinafter, the number of transmission antennas is Nₜₓ, the number of receiving antennas is Nᵣₓ, the speed of light is c, and the irradiation time of each transmission antenna 102 (respective irradiation start time) is tᵢ (i=1, 2, 3, . . . , Nₜₓ). In addition, the case where a radar image is generated from radar signals by all transmission antennas 102 and all receiving antennas 103 is used as an example. Note that, for simplicity of explanation, the case where each of the transmission antennas 102 irradiates electromagnetic waves only once is used as an example. However, practically, the irradiation of electromagnetic waves from each of the transmission antennas 102 is repeated. The irradiation times of each transmission antenna are assumed to be equally spaced.

The case is assumed as an example where the radar device 101 performs imaging with motion compensation using the object position at the irradiation time (irradiation start time in the whole) ti as the compensation reference position. That is, in FIG. 2, when the position of the object 800 at the irradiation time ti is position #1 and the position of the object 800 at the irradiation time t_{Ntx} is position #2, the radar device 101 performs imaging (in this example embodiment, motion-compensated imaging) with position #1 as the reference. Note that those conditions are examples for simplicity of explanation, and this example embodiment and other example embodiments are not limited by those conditions.

The movement estimation unit 106 includes an image database (image DB) 107 that stores images and imaging times, an image generating unit 108 that generates a radar image using radar signals from the radar signal transmission and receiving unit 104 as an input and stores the radar image and the imaging time in the image DB 107, and a movement amount estimation unit 110 that estimates the movement of the object based on the images with different imaging times.

The movement estimation unit 106 inputs a signal from the sensor 105 or the radar signal and outputs the estimated movement amount of the object 800 at the irradiation time of each transmission antenna 102 to the motion-compensated image generating unit 112. There are several possible estimation methods for the movement estimation unit 106. Example are the following methods.

Method A:

The movement estimation unit 106 estimates the movement of the object 800 based on the signals from the sensor 105. The movement estimation unit 106 obtains, for example, a position or a velocity of the object 800 from the sensor 105, and estimates the movement amount from them. As the sensor 105, for example, an ultrasonic sensor, VICON (a motion capture system by Vicon Motion Systems), a radar that measures distance and velocity, and the like can be used. The sensor 105 is installed at a point on the object 800 where its velocity is easily obtained relative to its movement. For example, the sensor 105 is installed in front of the direction of movement of the object 800.

When the information obtained from the sensor 105 is information of the position of the object 800, the result is as shown in FIG. 3. FIG. 3 is an explanatory diagram showing a position of an object at each time. Specifically, FIG. 3 shows a graph in which the estimated position P′(t) of the object 800 at time t and the actual position P(t) of the object 800 are plotted. The movement estimation unit 106 can calculate the movement amounts Δ(tᵢ) of the object at the irradiation time of the electromagnetic wave of each transmission antenna 102 from the estimated position P′(t) using the following equation (1). Note that if a sensor 105 outputting a signal indicating position or velocity information is used, the signal may be temporarily stored in a DB.

[Math. 1]

\vec{Δ(tₗ)}=P′(tᵢ)−P′(t₁) (1)

Suppose that the estimated position P′(t) is expressed by three-dimensional data of x, y, and z. When a sensor 105 that outputs one-dimensional or two-dimensional data is used, the movement estimation unit 106 estimates only the movement amount of the obtained one-dimensional or two-dimensional data. When the information obtained from the sensor 105 is the velocity of the object at the irradiation time, v_{xyz}(t)={vx, vy, vz}, the movement amount of the object 800, Δ(ti) can be calculated using the following equation (2), assuming that the velocity of the object 800 in the irradiation period is constant.

[Math. 2]

\vec{Δ(tₗ)}=(vx·(tᵢ−t₁), vy·(tᵢ−t₁), vz·(tᵢ−t₁)) (2)

Method B:

The movement estimation unit 106 estimates the movement of the object 800 based on an image from the sensor 105. When Method B is adopted, in the movement estimation unit 106, the image DB 107 stores images and imaging times. The movement amount estimation unit 110 estimates the movement of the object based on the images with different imaging times. As the sensor 105, for example, a two-dimensional camera, a depth camera, or the like can be used. Note that it is assumed that the sensor 105 is installed at the same position as the radar 804 (i.e., on the side panel 803 in FIG. 18).

Method C:

The movement estimation unit 106 estimates the movement of the object using a radar image based on the radar signals obtained from the receiving antenna 103. When Method C is adopted, the image generating unit 108 that generates a radar image based on the radar signals is utilized in the movement estimation unit 106. The image DB 107 stores the radar images and the imaging times. The movement amount estimation unit 110 estimates the movement of the object based on the radar images with different imaging times.

Note that, in the case where Method A or Method B is adopted, the image generating unit 108 may not be comprised in the movement estimation unit 106.

When Method C is used, the image generating unit 108 inputs radar signals from the radar signal transmission and receiving unit 104, generates radar images, and stores the radar images and the imaging times in the image DB 107. The image generating unit 108 calculates the imaging time based on each irradiation time of the transmission antenna 102 received from the radar signal transmission and receiving unit 104. The image generating unit 108, for example, assumes that the imaging time of the radar image is (t_{Ntx}+t₁)/2, which is an average value of the irradiation times, when all the transmission antennas 102 are used. The image generating unit 108 generates the radar image by beamforming, for example. That is, the image generating unit 108 generates the radar image using the following equations (3) and (4). Note that the method of generating the radar image is not limited to beamforming. The image generating unit 108 can generate the radar image using any imaging method.

$$\begin{matrix}[ Math . 3 ] & \\ vim {g}_{i , j} ( \vec{v} ) = {\sum }_{i}^{Ntx} {\sum }_{j}^{N r x} {s}_{i , j} ( t ) * {e}^{\frac{2 π j \cdot f ( t )}{c} \{ \vert \vec{{R}_{ι}} - \vec{v} \vert + \vert \vec{{R}_{J}} - \vec{v} \vert \}} & ( 3 ) \\ [ Math . 4 ] & \\ vimg ( \vec{v} ) = {\sum }_{i}^{N t x} {\sum }_{j}^{N r x} v i m {g}_{i , j} ( \vec{v} ) & ( 4 )\end{matrix}$$

Take v(v ∈ V) for an imaging position when the whole area of the radar image is V. vimg_{i,j}(v) is an radar image of the imaging position v generated from the radar signals by the transmission antenna i and the receiving antenna j, respectively. |Rᵢ−v| and |Rⱼ−v| denote distances from the imaging position v to the transmission antenna i and the receiving antenna j, respectively. vimg(v) is the final radar image at the imaging position v. s_{i,j}(t) is the radar signal.

The plurality of radar images with different imaging times may not necessarily be generated based on the same combination of transmission antenna and receiving antenna. However, if the radar images are not generated based on the same combination of transmission antenna and receiving antenna, transmission and receiving antenna pairs each of which is combination of the transmission antenna 102 and the receiving antenna 103, that center positions of antenna apertures formed by the pairs are the same or close (for example, adjacent), are used. Alternatively, a plurality of radar images with different imaging times are generated under the conditions that the number of transmission antennas is the same, the irradiation time of electromagnetic waves of the transmission antennas is the same, and the aperture lengths by the transmission antenna and the receiving antenna are the same. For example, in a MIMO configuration consisting of four radar modules with eight transmission antennas and eight receiving antennas as illustrated in FIG. 20, the movement amount of the object 800 may be estimated by comparing a radar image generated by half of the transmission antennas irradiating electromagnetic waves in the first half of the period with a radar image generated by the remaining transmission antennas irradiating electromagnetic waves in the second half of the period that were not used in the first half of the period.

When Method B or Method C is used, the movement amount estimation unit 110 estimates the movement amount of the object 800 by image processing based on images (radar images or images from the sensor 105) with different imaging times. However, the difference time of the imaging times of the images used is substantially short for the movement of the object 800. For example, the difference time is less than or equal to a time interval that can be approximated by first order approximation (Taylor expansion in one dimension) when the position of the object 800 is expressed as a function of time. As with the case where Method A is used, there are primarily two methods of estimating the movement amount of the object 800.

In the first method, the movement amount estimation 110 first uses a single image. The movement amount estimation unit 110 estimates a position of the object from the single image. Next, the movement amount estimation unit 110 derives the estimated position P′(t), for example, by linear regression from the estimated positions of the object in a plurality of images with different imaging times. Then, the movement amount estimation unit 110 calculates the movement amount Δ(tᵢ) of the object using the equation (1). When the area or volume of the object 800 is large, the movement amount estimation unit 110 can use, for example, the centroid of the object 800 as the position of the object 800.

In the second method, the movement amount estimation unit 110 uses images with different imaging times and estimates the movement amount by comparing the plurality of images. The movement amount estimation unit 110 can, for example, use a point where the correlation value is high (shift value) among the images as the movement amount. The movement amount estimation unit 110 may also utilize phase only correlation or an optical flow-based method as described in non-patent literature 2. When the difference time of the imaging times is greater than the sum of the irradiation times of all the transmission antennas 102, the movement amount estimation unit 110 may calculate the movement velocity of the object 800 by dividing the calculated movement amount by the difference time of the imaging times, and estimate the movement amount using, for example, equation (2). In this case, it is assumed that the movement velocity of the object 800 is constant between different imaging times.

When Method C is used, for example, when the movement amount of the object 800 estimated from the images at the imaging times T₁, T₂ is d, the movement velocity of the object 800 is v_{xyz}(t)=d/(T₁−T₂). This movement velocity corresponds to the slope of the estimated position P′(t) in FIG. 4. The movement amount estimation unit 110 can estimate the movement amount of the object 800 at each irradiation time using the movement velocity of the object 800 and the equation (2).

When the shift value (movement amount) is estimated based on the correlation between radar images, the result is obtained as shown in FIG. 5. FIG. 5 shows an example of the estimated movement amount and its correlation value. The movement amount estimation unit 110 may use only d₁ which has the highest correlation value, as the movement amount. If there are a plurality of peaks, the movement amount estimation unit 110 may select a plurality of movement amounts such as d₁ and d₂. The movement amount estimation unit 110 may also use an average value of d₁ and d₂ as the movement amount.

Note that FIG. 5 shows only the movement amount in one dimension (x, y, or z) as an example, and the movement amount estimation unit 110 can also estimate the movement amount in three dimension by taking correlation for three-dimensional images. In the case where the optical flow-based method is used, when a plurality of values are estimated as the movement amount of the object 800, the movement amount estimation unit 110 may select the maximum value or the average value, or a plurality thereof.

The motion-compensated image generating unit 112 generates a radar image based on the radar signals input from the radar signal transmission and receiving unit 104 and the movement amounts of the object at the irradiation times of the respective transmission antennas 102 input from the movement estimation unit 106. The motion-compensated image generating unit 112 outputs the generated radar image. The motion-compensated image generating unit 112 performs, for example, motion-compensated imaging based on beamforming. That is, the motion-compensated image generating unit 112 obtains the motion-compensated final radar image by using the following equation (5), using the movement amounts Δ(tᵢ) of the object at the irradiation times of the electromagnetic waves of the respective transmission antennas 102.

[Math. 5]

vimg(\vec{v})=Σᵢ^{Ntx}Σⱼ^{Nrx}vimg_{i,j}(\vec{v}+\vec{Δ(tₗ)}) (5)

When generating the final radar image, the motion-compensated image generating unit 112 shifts the imaging position for each transmission antenna 102 by the movement amount and adds the plurality of radar images together. In equation (5), it is assumed that there is no movement of the object 800 during the irradiation period of the electromagnetic wave by one transmission antenna 102. However, if the movement amount of the object 800 during irradiation with one transmission antenna 102 (while changing the frequency) is large, the motion-compensated image generating unit 112 should shift the imaging position by the movement amount in units of frequency. If there are multiple movement amounts of the object 800 received from the movement estimation unit 106, the motion-compensated image generating unit 112 can perform motion-compensated imaging using the equation (5) for each movement amount.

Next, the operation of the radar system in the first example embodiment will be described with reference to the flowcharts of FIGS. 6A-6C. FIG. 6A shows the entire processing of the radar system. FIG. 6B and FIG. 6C show processes executed by the movement estimation unit 106.

The radar signal transmission and receiving unit 101 makes the plurality of transmission antennas 102 emit electromagnetic waves sequentially according to a predetermined irradiation order, and obtains radar signals based on the reflected waves received by the receiving antennas 103 (step S101). The radar signal transmission and receiving unit 104 outputs the radar signal and the irradiation time of each transmission antenna to the motion-compensated image generating unit 112.

Note that the movement amount estimation of the object 800 based on the signal (signal that can identify the position or velocity or image of the object 800) from the sensor 105 and the movement amount estimation based on the radar image are executed alternatively. When the radar device 101 is configured to perform the movement amount estimation based on the radar image, the radar signal transmission and receiving unit 104 also outputs the radar signal and the irradiation time of each transmission antenna to the movement estimation unit 106.

In step S102, the movement estimation unit 106 inputs signals related to the position, velocity, or image of the object 800 from the sensor 105. When the sensor 105 capable of outputting an image is used, the image from the sensor 105 is stored in the image DB 107. Note that in the case where the radar device 101 is configured to perform movement amount estimation based on the radar image, the movement estimation unit 106 does not execute the processing of step S102. In addition, when the radar device 101 is so configured, the sensor 105 need not be installed as described above.

In the movement estimation unit 106, the movement amount estimation unit 110 estimates the movement amount of the object 800 at the irradiation time of each transmission antenna 102 (step S103). The movement amount estimation unit 110 outputs the estimated movement amount of the object 800 to the motion-compensated image generating unit 112.

When the above described Method B is used, the processing of step S103B shown in FIG. 6B is executed as the processing of step S103. That is, the images from the sensor 105 are stored in the image DB 107 (step S131), and the movement amount estimation unit 110 estimates the movement amount of the object 800 at the irradiation time of each transmission antenna 102 based on the images of different imaging times stored in the image DB 107 (step S132).

When the above described Method C is used, the processing of step S103C shown in FIG. 6C is executed as the processing of step S103. That is, first, in the movement estimation unit 106, the image generating unit 108 inputs the radar signal from transmission and receiving unit 104, and generates a radar image (step S134). The image generating unit 108 stores the generated radar image and the imaging time in the image DB 107 (step S135). The movement amount estimation unit 110 estimates the movement amount of the object 800 at the irradiation time of each transmission antenna 102 based on the radar images of different imaging times stored in the image DB 107 (step S136).

Note that when the above described Method A is used, the movement amount estimation unit 110 can estimate the movement amount of the object 800 directly from the signal from the sensor 105.

The motion-compensated image generating unit 112 generates a radar image from the radar signals input from the radar signal transmission and receiving unit 104 based on the estimated movement amount input from the movement estimation unit 106, for example, using the equation (5) (step S104).

In this example embodiment, the radar device 101 estimates the movement of the object 800 using the information (information of position or velocity) or the image obtained from the sensor 105, or the radar image. Then, the radar device 101 generates a radar image by compensating for the estimated movement of the object 800. As a result, a radar image with blur suppressed is obtained.

### Example Embodiment 2

FIG. 7 is a block diagram showing a configuration example of the radar system of the second example embodiment. The radar system of the second example embodiment includes a radar device 201, a transmission antenna 102, a receiving antenna 103, and a sensor 105. Although one transmission antenna 102 and one receiving antenna 103 are illustrated in FIG. 7, practically, a large number of transmission antennas 102 and a large number of receiving antennas 103 are installed.

The radar device 201 includes a radar signal transmission and receiving unit 104, a movement estimation unit 206 that estimates a movement of an object, and a motion-compensated image generating unit 212 that generates a radar image using radar signals and the estimated movement of the object.

The movement estimation unit 206 includes an image DB 107, an image generating unit 108, an interest point extraction unit 209 that extracts one or more interest points in the object 800, and a movement amount estimation unit 210 that estimates the movement of the object based on images with different imaging times. The movement amount estimation unit 210 in the movement estimation unit 206 estimates the movement of the interest points. In this example embodiment, in the movement estimation unit 206, the movement amount estimation unit 210 estimates the movement amount for each interest point extracted by the interest point extraction unit 209.

The transmission antenna 102, the receiving antenna 103, the radar signal transmission and receiving unit 104, the sensor 105, the image DB 107, and the image generating unit 108 have the same functions as those of the first example embodiment.

Similar to the movement estimation unit 106 in the first example embodiment, the movement estimation unit 206 can input the signal from the sensor 105 or the radar signal and use three methods (Method A, Method B, and Method C). In this example embodiment, the movement estimation unit 206 outputs the movement amount for each interest point at the irradiation time of each transmission antenna 102 to the motion-compensated image generating unit 212.

When Method A is used, the movement estimation unit 206 estimates the movement amount for each interest point in a process similar to the process by the movement estimation unit 106 in the first example embodiment. For example, when the object 800 is a pedestrian, the movement estimation unit 206 estimates the movement amount for each part such as a hand, a foot, and a torso.

When Method B or Method C is used, the interest point extraction unit 209 extracts one or more interest points from the images (radar images or images from the sensor 105) stored in the image DB 107. The interest point extraction unit 209 outputs the positions of the extracted interest points and the images with different imaging times to the movement amount estimation unit 210. For example, the interest point extraction unit 209 automatically extracts the interest point from the image of the imaging time close to the irradiation time that becomes the reference position by corner detection or the like. The interest point extraction unit 209 may extract a predetermined point. The predetermined point is, for example, a point on a grid that divides the image into equal intervals.

FIG. 8 is an explanatory diagram showing an example of an interest point extracted by corner detection. Image #1 is an image at an imaging time close to the irradiation time that becomes a reference position. Image #2 is an image at an imaging time different therefrom. In the example shown in FIG. 8, interest points #1, #2, #3, and #4 are extracted from image #1. The extracted interest points are denoted as pk (1≤k≤Np).

When an interest point is extracted based on the image obtained from the sensor 105, the coordinates of the interest point are transformed into the coordinates of the image obtained by the radar device 201. Existing alignment (registration) techniques and the like can be used for the coordinate transformation.

The movement amount estimation unit 210 estimates the movement amount of each interest point at the irradiation time of each transmission antenna 102 using images with different imaging times. The movement amount estimation unit 210 outputs the estimated movement amount to the motion-compensated image generating unit 212. In the example shown in FIG. 8, an arrow extending from each interest point represents the movement amount of each interest point. The movement amount estimation unit 210 can use an existing correlation method, optical flow, or the like, when estimating the movement amount of each interest point. Assuming that the movement amount of each interest point at the irradiation time of each transmission antenna 102 is Δₚ(tᵢ), the movement amount of each interest point can be expressed by the following equation (6). In equation (6), P′p(tᵢ) indicates the estimated position of the interest point pk at time tᵢ.

[Math. 6]

\vec{Δₚ(tₗ)}=P′ₚ(tᵢ)−P′ₚ(t₁) (6)

When v_{p,xyz}(t)={vxₚ, vyₚ, vzₚ} is assumed as the velocity of each interest point calculated from the movement amount of the interest point estimated between images with different imaging times and the difference time of the imaging times, the movement amount estimation unit 210 can calculate the movement amount of each interest point by the following equation (7) as well as equation (2).

[Math. 7]

\vec{Δₚ(tₗ)}=(vxₚ·(tᵢ−t₁), vyₚ·(tᵢ−t₁), vzₚ·(tᵢ−t₁)) (7)

The motion-compensated image generating unit 212 generates a radar image based on the radar signal input from the radar signal transmission and receiving unit 104 and the movement of each interest point at an irradiation time of each transmission antenna 102 input from the movement estimation unit 206. The motion-compensated image generating unit 212 outputs the generated radar image. The motion-compensated image generating unit 212 performs, for example, motion-compensated imaging based on beamforming. That is, the motion-compensated image generating unit 212 obtains a motion-compensated radar image using the following equation (8) by using the movement amount Δₚ(tᵢ) of each interest point of the object at the irradiation time of the electromagnetic wave of each transmission antennas 102.

[Math. 8]

vimgₚ(\vec{v})=Σᵢ^{Ntx}Σⱼ^{Nrx}vimg_{i,j}(\vec{v}+\vec{Δₚ(tₗ)}) (8)

Nₚ, which is the number of interest points, radar images are generated based on the equation (8). Similar to the equation (5), it is assumed that there is no movement of the object 800 during the irradiation period of the electromagnetic wave at one transmission antenna 102 in the equation (8). However, if the movement amount of the object 800 during irradiation with one transmission antenna 102 (while changing the frequency) is large, the motion-compensated image generating unit 212 should shift the imaging position by the movement amount in units of frequency.

Next, the operation of the radar system of the second example embodiment will be described with reference to the flowcharts of FIGS. 9A-9C. FIG. 9A shows the entire processing of the radar system. FIG. 9B and FIG. 9C show processes executed by the movement estimation unit 206.

The processing of steps S101 and S102 is the same as the processing in the first example embodiment.

In this example embodiment, the movement amount estimation of the object 800 based on the signal (signal that can identify the position or velocity or image of the object 800) from the sensor 105 and the movement amount estimation based on the radar image are also executed alternatively. When the radar device 201 is configured to perform the movement amount estimation based on the radar image, the radar signal transmission and receiving unit 104 also outputs the radar signal and the irradiation time of each transmission antenna to the movement estimation unit 206.

In the case where the radar device 201 is configured to perform the movement amount estimation based on the radar image, the movement estimation unit 206 does not execute the processing of step S102. In the case where the radar device 201 is so configured, the sensor 105 need not be installed as described above.

In the movement estimation unit 206, the movement amount estimation unit 210 estimates the movement amount of the object 800 (step S203). The movement amount estimation unit 210 outputs the estimated movement amount of the object 800 to the motion-compensated image generating unit 212.

When Method B described above is used, the processing of step S203B shown in FIG. 9B is executed as the processing of step S203. That is, the image from the sensor 105 is stored in the image DB 107 (step S231), and the interest point extraction unit 209 extracts one or more interest points pk from the image from the sensor 105 stored in the image DB 107 (step S232). Note that the processing of step S231 is the same as the processing of step S131 in the first example embodiment. The interest point extraction unit 209 outputs the extracted positions of the interest points and the images with different imaging times to the movement amount estimation unit 210. The movement amount estimation unit 210 estimates the movement amount Δₚ(tᵢ) for each interest point (step S233). The movement amount estimation unit 210 outputs the estimated movement amounts of the interest points to the motion-compensated image generating unit 212.

When the above described Method C is used, the processing of step 5203C shown in FIG. 9C is executed as the processing of step S203. That is, in the movement estimation unit 206, the image generating unit 108 inputs radar signals from the radar signal transmission and receiving unit 104, and generates a radar image (step S234). The image generating unit 108 stores the generated radar image and the imaging time in the image DB 107 (step S235). Note that the processing of steps S234 and S235 is the same as the processing of steps S134 and S135 in the first example embodiment. The interest point extraction unit 209 extracts one or more interest points pk from the radar images of different imaging times stored in the image DB 107 (step S236). The interest point extraction unit 209 outputs the extracted positions of the interest points and the radar images with different imaging times to the movement amount estimation unit 210. The movement amount estimation unit 210 estimates the movement amount for each interest point. The movement amount estimation unit 210 outputs the estimated movement amounts of the interest points to the motion-compensated image generating unit 212.

The motion-compensated image generating unit 212 generates a radar image from the radar signals input from the radar signal transmission and receiving unit 104, based on the estimated movement amount from the movement estimation unit 206, using equation (8), for example (step S104).

In this example embodiment, the radar device 201 estimates the movement of each interest point in the object 800 using information (position or velocity information) or images obtained from the sensor 105, or radar images. Then, the radar device 201 generates a radar image by compensating for the movements of the estimated interest points. As a result, a radar image is obtained in which blurring caused by different movements at multiple positions in the object 800 is suppressed.

### Example Embodiment 3

FIG. 10 is a block diagram showing a configuration example of the radar system of the third example embodiment. The radar system of the third example embodiment includes a radar device 301, a transmission antenna 102, a receiving antenna 103, and a sensor 105. Although one transmission antenna 102 and one receiving antenna 103 are illustrated in FIG. 10, practically, a large number of transmission antennas 102 and a large number of receiving antennas 103 are installed.

The radar device 301 includes a radar signal transmission and receiving unit 104, a movement estimation unit 206 that estimates a movement of an object, an image area divider 311 that divides a radar image into areas, and a motion-compensated image generating unit 312 that generates a radar image using the radar signals and the estimated movement of the object.

The transmission antenna 102, the receiving antenna 103, the radar signal transmission and receiving unit 104, the sensor 105, and the movement estimation unit 206 have the same functions as those of the second example embodiment shown in FIG. 7. Accordingly, the image DB 107, the image generating unit 108, the interest point extraction unit 209, and the movement amount estimation unit 210 have the same functions as those of the second example embodiment.

In this example embodiment, the movement estimation unit 206 inputs the signal from the sensor or the radar signal, and outputs the movement amount for each interest point and the position of the interest point at the irradiation time of each transmission antenna 102 to the image area divider 311.

The image area divider 311 divides the image (radar image or image from the sensor 105) into areas based on the positions of the interest points. The image area divider 311 outputs the area obtained by the division and the movement amount of the corresponding interest point to the motion-compensated image generating unit 312. The image area divider 311 can, for example, divide an image by clustering with an interest point as a mother point. As a division method, for example, division by a Voronoi diagram can be used. That is, the image area divider 311 can divide an image into areas (area division) by mapping a pixel (in this case, an imaging position) in the image to the nearest interest point among a plurality of interest points (kernel points), and defining an area in which the pixel corresponding to the interest point is an element.

FIG. 11 is an explanatory diagram showing an example of an area divided image based on an interest point. FIG. 11 shows an example of an area divided based on the position of an interest point in image #1 illustrated in FIG. 8.

The areas corresponding to the interest points #1, #2, #3, and #4 denote the areas #1, #2, #3, and #4. The whole area of the image denotes v ∈ V, and the divided areas denote vₚ ∈ Vₚ(p=1, 2, . . . , Nₚ), which can be expressed in general as {V₁ ∪ V₂ ∪ . . . V_{Np}}=V.

The motion-compensated image generating unit 312 generates a radar image for each area based on the radar signals input from the radar signal transmission and receiving unit 104 and the movement of an interest point corresponding to the area obtained by the division. The motion-compensated image generating unit 312 outputs the generated radar image. That is, the motion-compensated image generating unit 312 obtains a motion-compensated radar image using the following equation (9) for each area vₚ ∈ Vₚ in the image, using the movement amount Δₚ(tᵢ) for each interest point of the object at the irradiation time of the electromagnetic waves of the respective transmission antennas 102.

[Math. 9]

vimg(\vec{vₚ})=Σᵢ^{Ntx}Σⱼ^{Nrx}vimg(\vec{vₚ}+\vec{Δₚ(tₗ)}) (9)

FIG. 12 is an explanatory diagram showing the movement amount corresponding to the area obtained by division. Imaging is performed for the area #1 and the area #3 shown in FIG. 11 based on different movement amounts Δ₁(tᵢ) and Δ₃(tᵢ). In FIG. 12, the thin dotted line indicates the area #1. The solid thin line indicates the area #3. The bold dotted line indicates the area #1 shifted by the movement amount of the interest point corresponding to the area #1. The bold solid line indicates the area #3 shifted by the movement amount of the interest point corresponding to the area #3. Since the same calculation is performed for an overlapped part by the areas that are shifted by the movement amount, the motion-compensated image generating unit 312 may use a cache for the overlapped part.

Next, the operation of the radar system of the third example embodiment will be described with reference to the flowcharts of FIGS. 13A-13C. FIG. 13A shows the entire processing of the radar system. FIG. 13B and FIG. 13C show processes executed by the movement estimation unit 206.

The processing of steps S101, S102, and S203 is the same as the processing in the second example embodiment. The movement estimation unit 206 outputs the movement amount for each interest point and the position of the interest point at the irradiation time of each transmission antenna 103 to the image area divider 311.

In this example embodiment, the movement amount estimation of the object 800 based on the signal from the sensor 105 (signal that can identify the position or velocity or image of the object 800) and the movement amount estimation based on the radar image are also alternatively executed. When the radar device 301 is configured to perform the movement amount estimation based on the radar image, the radar signal transmission and receiving unit 104 also outputs the radar signal and the irradiation time of each transmission antenna to the movement estimation unit 206.

In the case where the radar device 301 is configured to perform the movement amount estimation based on the radar image, the movement estimation unit 206 does not execute the processing of step S102. In the case where the radar device 301 is so configured, the sensor 105 need not be installed as described above.

The image area divider 311 divides the image based on the positions of the interest points (step S301). The image area divider 311 outputs data indicating areas in the image obtained by dividing and movement amounts of corresponding interest points to the motion-compensated image generating unit 312.

The motion-compensated image generating unit 312 generates a radar image of each divided area based on the radar signals input from the radar signal transmission and receiving unit 104 and the movement amount of each interest point at an irradiation time of each transmission antenna 102 output from the image area divider 311. Then, the motion-compensated image generating unit 312 generates the radar image by equation (9), for example (step S304).

In this example embodiment, the radar device 301 estimates the movement of each interest point in the object 800 using information (position or velocity information) or images obtained from the sensor 105, or radar images. Then, the radar device 301 generates a final radar image by compensating for the movements of the estimated interest points. As a result, a radar image is obtained in which blurring caused by different movements of a plurality of positions in the object 800 is suppressed. In addition, even when the movements of the plurality of positions in the object 800 are different, it is possible to obtain a single radar image in which they are compensated simultaneously.

### Example Embodiment 4

FIG. 14 is a block diagram showing a configuration example of the radar system of the fourth example embodiment. The radar system of the fourth example embodiment includes a radar device 401, the transmission antenna 102, and the receiving antenna 103. Although one transmission antenna 102 and one receiving antenna 103 are illustrated in FIG. 14, practically, a large number of transmission antennas 102 and a large number of receiving antennas 103 are installed.

The radar device 401 includes a radar signal transmission and receiving unit 104, an image DB 107 that stores radar images and imaging times, an image generating unit 108 that generates a radar image based on the radar signals and stores the radar image and the imaging time in the image DB 107, an image area divider 411, a movement amount estimation unit 410 that estimates a movement of an object based on images with different imaging times, and a motion-compensated image generating unit 412 that generates a radar image using the radar signals and the movement amount estimated for each area obtained by the division.

The transmission antenna 102, the receiving antenna 103, the radar signal transmission and receiving unit 104, the image DB 107, and the image generating unit 108 have the same functions as those of the third example embodiment shown in FIG. 10.

The image area divider 411 obtains a radar image from the image DB 107 and divides the radar image into areas. The image area divider 411 outputs data indicating areas obtained by the division to the movement amount estimation unit 410. The image area divider 411 can use a clustering method such as the K-means method when dividing the radar image into areas. For example, the image area divider 411 may divide the image by making only the area around the pixel whose reflection intensity (amplitude) of the radar image is equal to or greater than a threshold value and clustering such as the K-means method on the limited area. A method for dividing the image may be predetermined. In such a case, the image area divider 411 may divide the image into N_{z} equally spaced areas in the z direction (depth direction relative to the radar plane), for example. The area obtained by dividing by clustering is denoted by Vₚ as in the case of the third example embodiment.

The movement amount estimation unit 410 estimates the movement amount of the object 800 in each area based on data indicating the divided area input to the image area divider 411. The movement amount estimation unit 410 outputs the estimated movement amount to the motion-compensated image generating unit 412. The movement amount estimation unit 410 can estimate the movement amount for each area using any of the methods used in the first to third example embodiments. The estimated movement amount for each image area is denoted as Δₚ(tᵢ).

The motion-compensated image generating unit 412 operates as in the third example embodiment.

Next, the operation of the radar system of the fourth example embodiment will be described with reference to the flowchart of FIG. 15.

The radar signal transmission and receiving unit 104 performs a process similar to that in the third example embodiment (step S101). The image generating unit 108 inputs the radar signals from the radar signal transmission and receiving unit 104 and generates a radar image, similar to the third example embodiment (step S234). The image generating unit 108 stores the generated radar image and the imaging time in the image DB 107 (step S235), as in the third example embodiment.

The image area divider 411 divides the image (radar image) stored in the image DB 107 into areas (step S401). The image area divider 411 outputs data indicating areas obtained by the division to the movement amount estimation unit 410.

The movement amount estimation unit 410 estimates the movement amount of the object 800 for each area in the image (step S402). The movement amount estimation unit 410 outputs the estimated movement amount to the motion-compensated image generating unit 412.

The motion-compensated image generating unit 412 generates a radar image similarly to the motion-compensated image generating unit 312, by equation (9), for example (step S304).

In this example embodiment, the radar device 401 estimates the movement of each interest point in the object 800 using the radar image. Then, the radar device 401 generates a final radar image by compensating for the movements of the estimated interest points. As a result, a radar image is obtained in which blurring caused by different movements of a plurality of positions in the object 800 is suppressed. In addition, even when the movements of the plurality of positions in the object 800 are different, it is possible to obtain a single radar image in which they are compensated simultaneously.

The functions (processes) in each of the above example embodiments may be realized by a computer having a processor such as a central processing unit (CPU), a memory, etc. For example, a program for performing the method (processing) in the above example embodiments may be stored in a storage device (storage medium), and the functions may be realized with the CPU executing the program stored in the storage device.

FIG. 16 is a block diagram showing an example of a computer with a CPU. The computer is implemented in a radar device. The CPU 1000 executes processing in accordance with a program stored in a storage device 1001 to realize the functions in the above example embodiments. That is, the computer realizes the functions of the radar signal transmission and receiving unit 104, the image generating unit 108, the movement amount estimation unit 110, 210, 410, the motion-compensated image generating unit 112, 212, 312, 412, the interest point extraction unit 209, and the image area divider 311, 411 in the radar devices 101, 201, 301, and 401 shown in FIGS. 1, 7, 10, and 14.

A graphics processing unit (GPU) may be used in place of or together with the CPU 1000. In addition, some of the functions in the radar devices 101, 201, 301, and 401 shown in FIGS. 1, 7, 10, and 14 may be realized by the semiconductor integrated circuit, and other portions may be realized by the CPU 1000 or the like.

The storage device 1001 is, for example, a non-transitory computer readable medium. The non-transitory computer readable medium includes various types of tangible storage media. Specific examples of the non-transitory computer readable medium include magnetic storage media (for example, flexible disk, magnetic tape, hard disk), magneto-optical storage media (for example, magneto-optical disc), compact disc-read only memory (CD-ROM), compact disc-recordable (CD-R), compact disc-rewritable (CD-R/W), and a semiconductor memory (for example, mask ROM, programmable ROM (PROM), erasable PROM (EPROM), flash ROM).

The program may be stored in various types of transitory computer readable media. The transitory computer readable medium is supplied with the program through, for example, a wired or wireless communication channel, or, through electric signals, optical signals, or electromagnetic waves.

The memory 1002 is a storage means implemented by a RAM (Random Access Memory), for example, and temporarily stores data when the CPU 1000 executes processing. It can be assumed that a program held in the storage device 1001 or a temporary computer readable medium is transferred to the memory 1002 and the CPU 1000 executes processing based on the program in the memory 1002.

The memory 1002 or the storage device 1001 realizes the image DB 107 in each of the above example embodiments.

FIG. 17 is a block diagram showing the main part of the radar system. The radar system 11 shown in FIG. 17 comprises a plurality of transmission antennas 12 (in the example embodiments, realized by the transmission antenna 102) which irradiate electromagnetic waves, a plurality of receiving antennas 13 (in the example embodiments, realized by the receiving antenna 103) which receive the irradiated electromagnetic waves that have been reflected and generating measurement signals, radar signal transmission and receiving means 14 (in the example embodiments, realized by the radar signal transmission and receiving unit 104) for obtaining the measurement signals, movement estimation means 15 (in the example embodiments, realized by the movement estimation unit 106, 206) for estimating the movement of an object, and motion-compensated image generation means 16 (in the example embodiments, realized by the motion-compensated image generating unit 112, 212, 312, 412) for generating a radar image, based on the measurement signals and the estimated object movement.

A part of or all of the above example embodiments may also be described as, but not limited to, the following supplementary notes.

(Supplemental note 1) A radar system comprising:

a plurality of transmission antennas which irradiate electromagnetic waves,

a plurality of receiving antennas which receive the irradiated electromagnetic waves that have been reflected and generating measurement signals,

radar signal transmission and receiving means for obtaining the measurement signals,

movement estimation means for estimating a movement of an object, and

motion-compensated image generation means for generating a radar image, based on the measurement signals and the estimated movement of an object.

(Supplemental note 2) The radar system according to Supplemental note 1, wherein

the movement estimation means includes movement amount estimation means for estimating the movement amount of the object at an irradiation time of the electromagnetic wave of each transmission antenna, and

the motion-compensated image generation means generates the radar image, based on the estimated movement amount of the object.

(Supplemental note 3) The radar system according to Supplemental note 2, wherein

the movement amount estimation means estimates the movement amount of the object at the irradiation time of each transmission antenna, based on images based on the measurement signals or images obtained from an external sensor with different imaging times.

(Supplemental note 4) The radar system according to Supplemental note 3, wherein

the movement amount estimation means obtains the movement amount of the object from correlation among a plurality of images with different imaging times, calculates movement velocity of the object based on the obtained movement amount and the difference of the imaging times, and estimates the movement amount of the object at the irradiation time of each transmission antenna from the calculated movement velocity.

(Supplemental note 5) The radar system according to Supplemental note 3, wherein

the movement amount estimation means estimates the movement amount of the object at the irradiation time of each transmission antenna, based on a plurality of images with different imaging times, wherein the images are based on the measurement signals obtained by combinations of the transmission antenna and the receiving antenna whose center positions of antenna apertures formed by the transmission antenna and the receiving antenna are the same or close.

(Supplemental note 6) The radar system according to any one of Supplemental notes 1 to 5, further comprising:

interest point extraction means for extracting one or more interest points in the object, wherein

the motion-compensated image generation means generates the radar image, based on the movement of the object for each interest point at the irradiation time of each transmission antenna.

(Supplemental note 7) The radar system according to Supplemental note 6, wherein

the interest point extraction means extracts interest points in the object from the image based on the measurement signals or an image obtained from an external sensor, and

the movement estimation means estimates the movement amount for each of the interest points at the irradiation time of each transmission antenna.

(Supplemental note 8) The radar system according to any one of Supplemental notes 1 to 7, further comprising:

image area division means for dividing the image, based on the interest points in the object, wherein

the motion-compensated image generation means generates the radar image, based on the movement of the interest point in each area obtained by the division.

(Supplemental note 9) The radar system according to Supplemental note 8, wherein

the image area division means divides the image so that a distance between the interest point and an imaging position is minimized.

(Supplemental note 10) The radar system according to any one of Supplemental notes 1 to 5, further comprising:

image area division means for dividing the image based on the measurement signals,

wherein

the movement estimation means estimates the movement of the object for each area obtained by the division, and

the motion-compensated image generation means generates the radar image, based on the movement of the object in each area obtained by division.

(Supplemental note 11) The radar system according to Supplemental note 10, wherein

the image area division means divides the image by clustering in the depth direction to the radar plane.

(Supplemental note 12) The radar system according to any one of Supplemental notes 1 to 11, wherein

the movement estimation means estimates the movement of the object, based on a position or velocity of the object obtained from an external sensor.

(Supplemental note 13) An imaging method comprising:

obtaining the measurement signals based on reflected waves of electromagnetic waves irradiated from a plurality of transmission antennas,

estimating a movement of an object, and

generating a radar image, based on the measurement signals and the estimated object movement.

(Supplemental note 14) The imaging method according to Supplemental note 13, further comprising

estimating the movement amount of the object at the irradiation time of the electromagnetic wave of each transmission antenna, and

generating the radar image, based on the estimated movement amount of the object.

(Supplemental note 15) The imaging method according to Supplemental note 14, wherein

the movement amount of the object at the irradiation time of each transmission antenna is estimated, based on images based on the measurement signals or images obtained from an external sensor with different imaging times.

(Supplemental note 16) An imaging program causing a computer to execute:

a process of obtaining the measurement signals based on reflected waves of electromagnetic waves irradiated from a plurality of transmission antennas,

a process of estimating a movement of an object, and

a process of generating a radar image based on the measurement signals and the estimated object movement.

(Supplemental note 17) The imaging program according to Supplemental note 16, causing the computer to further execute

a process of estimating the movement amount of the object at the irradiation time of the electromagnetic wave of each transmission antenna, and

a process of generating the radar image based on the estimated movement amount of the object.

(Supplemental note 18) The imaging program according to Supplemental note 17, wherein

the movement amount of the object at the irradiation time of each transmission antenna is estimated, based on images based on the measurement signals or images obtained from an external sensor with different imaging times.

Although the invention of the present application has been described above with reference to example embodiments, the present invention is not limited to the above example embodiments. Various changes can be made to the configuration and details of the present invention that can be understood by those skilled in the art within the scope of the present invention.

### REFERENCE SIGNS LIST

11 Radar system

12 Transmission antenna

13 Receiving antenna

14 Radar signal transmission and receiving means

15 Movement estimation means

16 Motion-compensated image generation means

101, 201, 301, 401 Radar device

102 Transmission antenna

103 Receiving antenna

104 Radar signal transmission and receiving unit

105 Sensor (external sensor)

106, 206 Movement estimation unit

107 Image DB (image database)

108 Image generating unit

110, 210, 410 Movement amount estimation unit

112, 212, 312, 412 Motion-compensated image generating unit

209 Interest point extraction unit

311, 411 Image area divider

1000 CPU

1001 Storage device

1002 Memory

What is claimed is:

1. A radar system comprising:
a plurality of transmission antennas which irradiate electromagnetic waves, a plurality of receiving antennas which receive the irradiated electromagnetic waves that have been reflected and generating measurement signals,
a radar signal transmission and receiving unit which obtains the measurement signals,
a movement estimation unit which estimates a movement of an object, and
a motion-compensated image generation unit which generates a radar image, based on the measurement signals and the estimated movement of an object.

2. The radar system according to claim 1, wherein
the movement estimation unit includes a movement amount estimation unit which estimates the movement amount of the object at an irradiation time of the electromagnetic wave of each transmission antenna, and
the motion-compensated image generation unit generates the radar image, based on the estimated movement amount of the object.

3. The radar system according to claim 2, wherein
the movement amount estimation unit estimates the movement amount of the object at the irradiation time of each transmission antenna, based on images based on the measurement signals or images obtained from an external sensor with different imaging times.

4. The radar system according to claim 3, wherein
the movement amount estimation unit obtains the movement amount of the object from correlation among a plurality of images with different imaging times, calculates movement velocity of the object based on the obtained movement amount and the difference of the imaging times, and estimates the movement amount of the object at the irradiation time of each transmission antenna from the calculated movement velocity.

5. The radar system according to claim 3, wherein
the movement amount estimation unit estimates the movement amount of the object at the irradiation time of each transmission antenna, based on a plurality of images with different imaging times, wherein the images are based on the measurement signals obtained by combinations of the transmission antenna and the receiving antenna whose center positions of antenna apertures formed by the transmission antenna and the receiving antenna are the same or close.

6. The radar system according to claim 1, further comprising:
an interest point extraction unit which extracts one or more interest points in the object, wherein
the motion-compensated image generation unit generates the radar image, based on the movement of the object for each interest point at the irradiation time of each transmission antenna.

7. The radar system according to claim 6, wherein
the interest point extraction unit extracts interest points in the object from the image based on the measurement signals or an image obtained from an external sensor, and
the movement estimation unit estimates the movement amount for each of the interest points at the irradiation time of each transmission antenna.

8. The radar system according to claim 6, further comprising:
an image area division unit which divides the image, based on the interest points in the object, wherein
the motion-compensated image generation unit generates the radar image, based on the movement of the interest point in each area obtained by the division.

9. The radar system according to claim 8, wherein
the image area division unit divides the image so that a distance between the interest point and an imaging position is minimized.

10. The radar system according to claim 1, further comprising:
an image area division unit which divides the image based on the measurement signals,
wherein
the movement estimation unit estimates the movement of the object for each area obtained by the division, and
the motion-compensated image generation unit generates the radar image, based on the movement of the object in each area obtained by division.

11. The radar system according to claim 10, wherein
the image area division unit divides the image by clustering in the depth direction to the radar plane.

12. The radar system according to claim 1, wherein
the movement estimation unit estimates the movement of the object, based on a position or velocity of the object obtained from an external sensor.

13. An imaging method comprising:
obtaining the measurement signals based on reflected waves of electromagnetic waves irradiated from a plurality of transmission antennas,
estimating a movement of an object, and
generating a radar image, based on the measurement signals and the estimated object movement.

14. The imaging method according to claim 13, further comprising
estimating the movement amount of the object at the irradiation time of the electromagnetic wave of each transmission antenna, and
generating the radar image, based on the estimated movement amount of the object.

15. The imaging method according to claim 14, wherein
the movement amount of the object at the irradiation time of each transmission antenna is estimated, based on images based on the measurement signals or images obtained from an external sensor with different imaging times.

16. A non-transitory computer readable information recording medium storing an imaging program causing a computer to execute:
obtaining the measurement signals based on reflected waves of electromagnetic waves irradiated from a plurality of transmission antennas,
estimating a movement of an object, and
generating a radar image based on the measurement signals and the estimated object movement.

17. The information recording medium according to claim 16, wherein the imaging program causes the computer to further execute
estimating the movement amount of the object at the irradiation time of the electromagnetic wave of each transmission antenna, and
generating the radar image based on the estimated movement amount of the object.

18. The information recording medium according to claim 17, wherein
the movement amount of the object at the irradiation time of each transmission antenna is estimated, based on images based on the measurement signals or images obtained from an external sensor with different imaging times.
